(19) United States
(12) Patent Application Publication
(10) Pub. No.: US 2002/0131266 A1
(43) Pub. Date: Sep. 19, 2002

(54) RING LIGHT AND METHOD OF USE

(76) Inventors: David Naghi, Los Angeles, CA (US); Eric A. Hanscom, Los Angeles, CA (US)

Correspondence Address: STEPHEN C. BEUERLE, PROCOPIO, CORY, HARGREAVES & SAVITCH, 530 B STREET, SUITE 2100, SAN DIEGO, CA, 92101-4469, US

(21) Appl. No.: 09/809,912

(22) Filed: Mar. 15, 2001

(51) Int. Cl. F21V 21/08

(52) U.S. Cl. 362/104; 362/806; 362/276; 362/395

(57) ABSTRACT

A ring light including a ring adapted to be inserted over a user's finger so that the finger extends both distally of and proximally of the ring, at least one power source carried by ring, at least one light source (preferably at least one Light Emitting Diode (“LED”)) powered by the at least one power source, and a shell covering the at least one power source and the at least one light source. A method of using the same includes providing the ring light over a user's finger so that the finger extends both distally of and proximally of the ring light, and actuating the at least one light source using a finger other than the finger used to carry the ring light. The step of providing a ring light over a user's finger may occur before or after the step of actuating the at least one light source.

### FIELD OF THE INVENTION

The present invention is in the field of ring lights and methods of use.

BACKGROUND OF THE INVENTION

Because much activity occurs at night-time, or in inadequate lighting conditions, individuals will often carry portable flashlights and other portable lights, e.g., key ring lights, with them in their cars, purse, key chain, etc. in the event they need to illuminate something to perform an activity, e.g., insert keys in a door lock. A problem with these portable lights is that they are not worn by the individual, so they must be found before they can be used. Because these portable lights are often small, they are easy to lose or misplace. As a result, when the need arises to use one of these portable lights, they often can not be found, or are not operational.

U.S. Pat. No. 5,632,548 to Mayfarth describes a fake thumb light worn by magicians that emits light, e.g., red light, through the fake thumb. The fake thumb light gives the magician the appearance of being able to pluck light out of thin air by simulating a plucking action with his or her hand. A problem with this light includes that it is not practical except for magicians or the like because nobody wants to wear a fake thumb on his or her hand to take advantage of the light-emitting aspect of this device. It is not practical to wear the fake thumb and perform normal activities because the fake thumb is clumsy and interferes with normal, everyday finger/hand use.

Accordingly, there is a need for a practical, inexpensive, simple lighting device that can be worn by an individual on his or her fingers that provides adequate lumination to perform an activity in otherwise inadequate lighting conditions.

### SUMMARY OF THE INVENTION

The present invention is generally directed to a ring light, and method of using the same.

An additional aspect of the invention involves a method of using a ring light. The method includes providing a ring light over a user's finger so that the finger extends both distally of and proximally of the ring light, the ring light including at least one light source and at least one power source; and actuating the at least one light source using a finger other than the finger used to carry the ring light. The step of providing a ring light over a user's finger may occur before or after the step of actuating the at least one light source. In a preferred implementation of the above method, the at least one light source is at least one Light Emitting Diode (“LED”).

Another aspect of the invention involves a ring light including a ring adapted to be inserted over a user's finger so that the finger extends both distally of and proximally of the ring, at least one power source carried by ring, at least one light source powered by power source, and a shell covering the power source and the light source. In a preferred implementation of the ring light, the at least one light source is at least one Light Emitting Diode (“LED”).

Further objects and advantages will be apparent to those skilled in the art with a review of the drawings and the detailed description of the preferred embodiments set forth below.

### BRIEF DESCRIPTION OF THE DRAWINGS

The drawings illustrate the design and utility of preferred embodiments of the present invention, in which:

FIG. 1 is a cross-sectional view of an embodiment of a ring light.

FIG. 2 is a top plan view of the ring light illustrated in FIG. 1 in use on a user's finger.

FIG. 3 is a cross-sectional view of an additional embodiment of a ring light.

FIG. 4 is a cross-sectional view of another embodiment of a ring light.

FIG. 5 is a cross-sectional view of a further embodiment of a ring light.

FIG. 6 is a side-elevational view of the ring light illustrated in FIG. 5 on a user's finger.

FIG. 7 is a top plan view of the ring light illustrated in FIG. 5 in use on a user's finger.

FIG. 8 is a cross-sectional view of a still further embodiment of a ring light.

FIG. 9 is a top plan view of another embodiment of ring light illustrated in use on a user's finger.

FIG. 10 is a cross-sectional view of a still further embodiment of a ring light in an “off” position.

FIG. 11 is a cross-sectional view of the ring light illustrated in FIG. 10 in an “on” position.

FIG. 12 is a top plan view of yet a further embodiment of a ring light.

### DETAILED DESCRIPTION OF THE PREFERRED EMBODIMENTS

With reference to FIG. 1, a ring light 100 constructed in accordance with an embodiment of the invention will now be described. The ring light 100 includes a ring 104 and a light housing 108. The ring 104 may come in a variety of sizes to accommodate different size fingers. The light housing 108 is disposed partially within a recessed area 112 of the ring 104.

The light housing 108 includes a generally hemispherical shell or housing 116 that covers at least one light source 120. The light source 120 is preferably a single, white LED. The LED may be a pointed LED, a square LED, a round LED, or the like. Further, the LED may be a variety of different colors other than white such as, but not by way of limitation, red, blue, green, and yellow. Other light sources, e.g., incandescent light bulbs, other angle LEDs, other color LEDs, and other numbers of LEDs, e.g., two or more, may be used.

The shell 116 may be made of plastic, glass or other material, and may be clear, tinted, or colored. The shell may be a magnifier to magnify or direct light, or a diffuser to diffuse or spread light. The shell 116 includes a dome 121 and an annular flange 122. The LED 120 is carried by a support surface 124. The support surface 124 may be integrally formed with the shell 116 or may be a separate element that is affixed to an inner surface 128 of the shell 116.

A first annular contact 132 may be affixed to an underside 136 of the flange 122. A second annular contact 140 may be affixed to an annular shelf 144. A first electrical coupling 148 connects the LED 120 to the first annular contact 132. A second electrical coupling 152 connects the first annular contact 132 to a negative terminal of at least one power source 156. A third electrical coupling 160 connects a positive terminal of the power source 156 to the LED 120. The aforementioned elements form an electrical circuit for powering the light source 120. The electrical circuit may include a dimmer mechanism, e.g., variable resistor, for controlling the brightness of the light source 120. Further, the electrical circuit may include an electronic mechanism that, once a user presses down on the shell 116 and releases it, the LED 120 is activated for a predetermined amount of time (e.g., 5 seconds) and then deactivated. The electrical circuit may include a standard on/off switch to control power to the LED 120. Further, the electrical circuit may include an electronic mechanism that causes the LED 120 to flash repeatedly.

The power source 156 is preferably a small, flat watch battery. In alternative embodiments, power sources other than batteries, e.g., miniature fuel cells, different types of batteries, e.g., rechargeable, and different numbers of batteries, e.g., two or more may be used. The ring light 100 may be disposable so that after the power source 156 is depleted of power, the ring light 100 is thrown away. Alternatively, the power source 156 may be changeable so that after the power source 156 is depleted of power, the power source 156 may be recharged, regenerated, or replaced. The battery 156 may be affixed to an electrically insulative support 164.

A spring 168 may be disposed between an upper surface 172 of the battery 156 and a lower surface 176 of the support 124 to bias the shell 116 upwards.

Preferably, the light housing 108 has a water-proof seal with the ring 104.

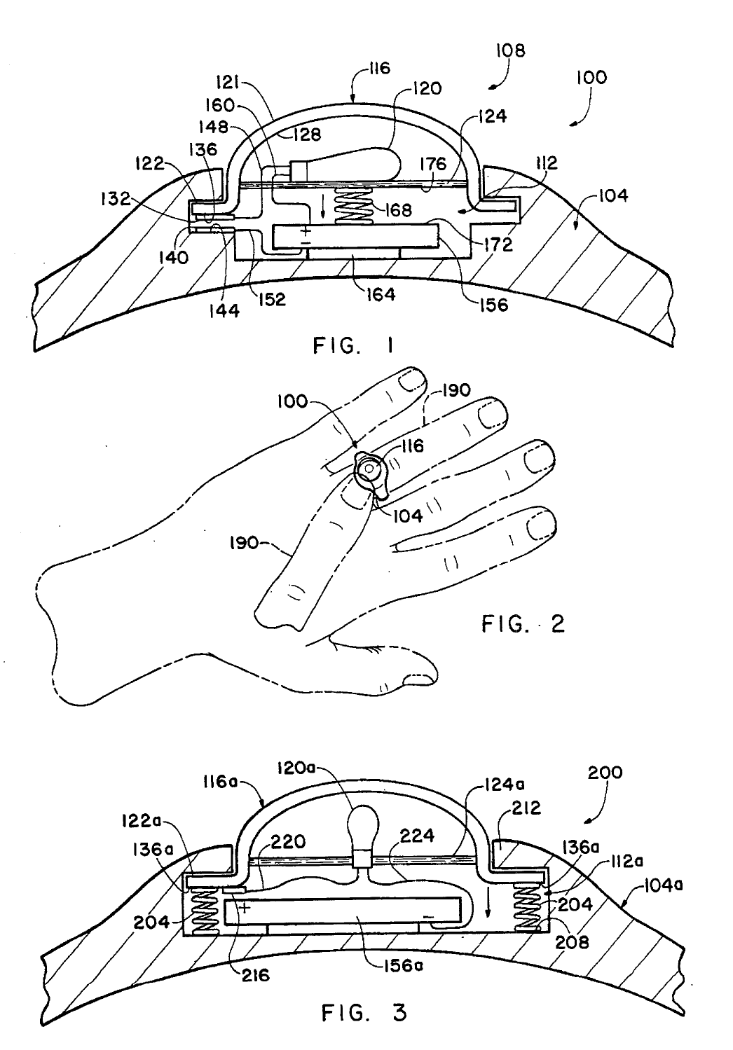

With reference additionally to FIG. 2, the ring light 100 will now be described in use. The ring light 100 is worn on a finger 190 of a user. Although the ring light 100 is shown on the ring finger of a user's left hand, the ring light 100 may be worn on any finger, including the thumb. Further, multiple ring lights 100 may be worn on one or more fingers 190 of a user. The ring light 100 is normally in an “off” condition. To actuate the ring light 100, a user presses down on the shell 116 of the ring light 100 using another finger 190. If the user presses hard enough to overcome the resistance force from the spring 168, the first annular contact 132 comes in electrical communication with the second annular contact 140, closing an electrical circuit including the LED 120 and battery 156. As a result, the battery 156 powers the LED 120, and the LED 120 is illuminated. The light from the LED 120 may be used for any lighting purpose. The LED 120 is deactivated by simply releasing the finger pressure on the shell 116. Releasing pressure on the shell 116 allows the spring 168 to urge the shell 116 upwards, preventing electrical communication between the first annular contact 132 and the second annular contact 140.

In an alternative method, the ring light 100 may include the aforementioned electronic mechanism that causes the LED 120 to be activated for a predetermined amount of time (e.g., 5 seconds) once a user presses down on the shell 116 and releases it. In this method, the user simply presses and releases the shell 116. The user does not have to maintain pressure on the shell 116 to keep the LED 120 activated. In a further method, the ring light 100 may have a standard on/off switch. In this method, instead of pushing on the shell 116, the user moves the on/off switch with another finger 190 to activate or deactivate the LED 120. In a still further method, the ring light may include an electronic mechanism that causes the LED 120 to flash repeatedly. In this method, the user simply presses and releases the shell 116 to cause the LED 120 to flash. For example, if the user presses the shell 116 once, the LED 120 may be activated in continuous mode (i.e., not flashing). If the user presses the shell twice quickly, the LED 120 may be activated in flashing mode. The LED 120 may be activated for a predetermined amount of time, or may be activated by pressing the shell 116 again. Any or all of these features and/or methods may also be incorporated in the embodiments described below.

With reference to FIG. 3, a ring light 200 constructed in accordance with an additional embodiment of the invention will now be described. Elements similar to those described above with respect to FIG. 1 are identified with like reference numerals, but with an “a” suffix. The ring light 200 includes a shell 116a that is biased upwards by multiple springs 204. The springs 204 are located between a recess floor 208 and the underside 136a of the annular flange 122a. Although two springs 204 are shown, more than two springs 204 may be used to bias the shell 116a upwards. An annular stop 212 retains the shell 116a in the recess 112a. A contact 216 is located on the underside 136a of the flange 122a. A first electrical coupling 220 connects the contact 216 to the LED 120a and a second electrical coupling 224 connects the LED 120a to a negative terminal of the battery 156a.

Use of the ring light 200 is similar to use of the ring light 100 described above with respect to FIG. 1, except when the shell 116a is pressed down, the contact 216 comes in direct physical and electrical communication with the positive terminal of the battery 156a, instead of another contact that is connected to the battery.

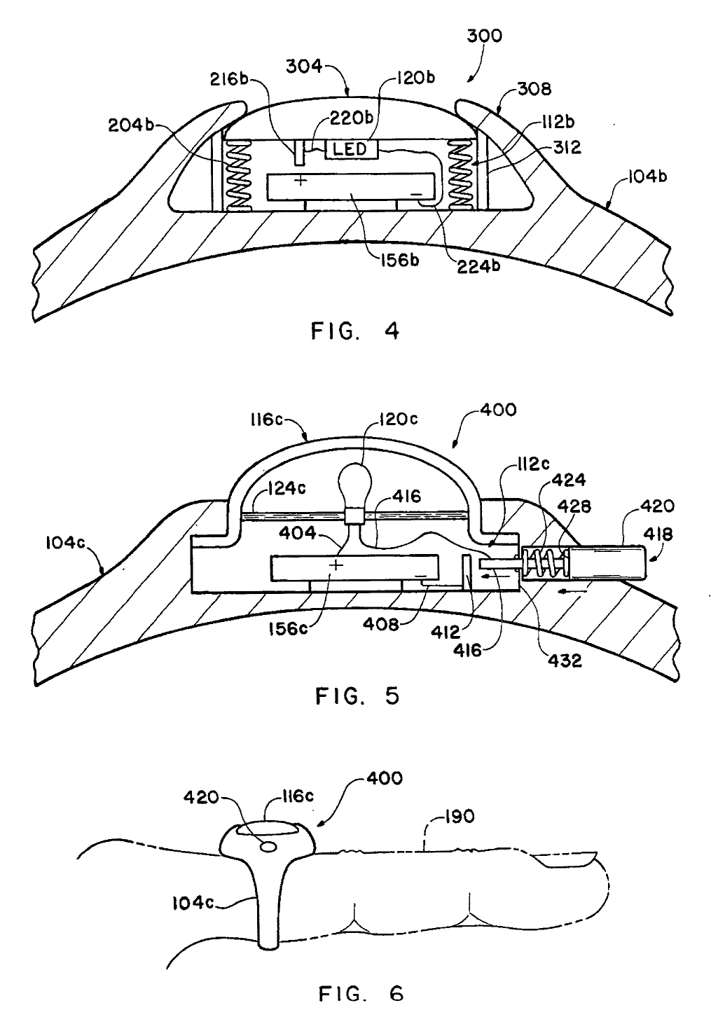

With reference to FIG. 4, a ring light 300 constructed in accordance with another embodiment of the invention will now be described. Elements similar to those described above are identified with like reference numerals, but with a “b” suffix. A disc-shaped shell or housing 304, preferably a gem or fake gem, is retained within the recess 112b by an annular base 308. Unlike the shells shown in FIGS. 1 and 3, the shell 304 does not project or extend vertically beyond the base 308. The shell 304 is retained laterally by annular support 312 and is biased upwards by the multiple springs 204b.

Use of the ring light 300 is similar to the use of the ring light 200 described above with respect to FIG. 3.

With reference to FIG. 5, a ring light 400 constructed in accordance with a further embodiment of the invention will now be described. Elements similar to those described above are identified with like reference numerals, but with a “c” suffix. Unlike the movable shells 116, 116a, 304 in the ring lights 100, 200, 300 described above, the shell 116c of the ring light 400 is fixed within the recess 112c of the ring 104c. A first electrical coupling 404 connects the LED 120c to a positive terminal of the battery 156c. A second electrical coupling 408 connects a negative terminal of the battery 156c to a stationary electrical contact 412. The stationary contact 412 is preferably flexible. A third electrical coupling 416 connects the LED 120c to a movable contact 416 of a push-button switch 418. The movable contact 416 is connected to a push button 420 of the push-button switch 418. A spring 424 is disposed between a sidewall 428 of the push button 420 and a sidewall 432 of the ring 104c. In an alternative embodiment, the push-button switch 418 may be replaced with a standard electrical on/off switch.

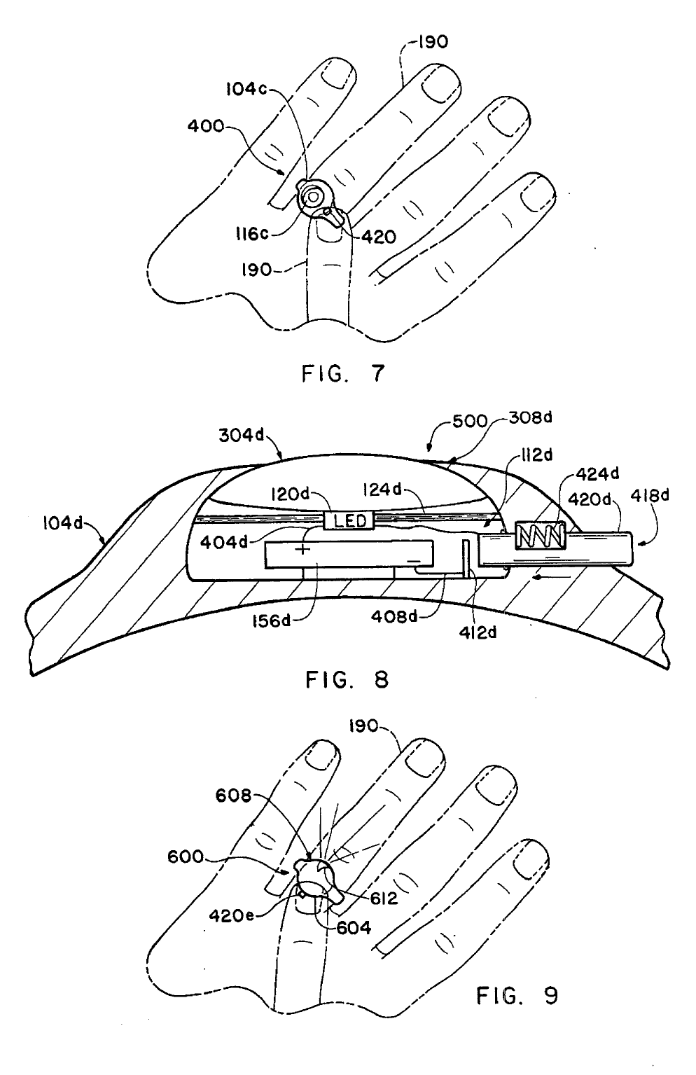

With reference additionally to FIGS. 6 and 7, the ring light 400 will now be described in use. Similar to the ring light 100 described with respect to FIGS. 1 and 2, the ring light 400 is normally in an “off” condition. To actuate the ring light 400, a user presses the push button 420 on the side of the ring light 400 using another finger 190. If the user presses hard enough to overcome the resistance force from the spring 424, the movable contact 416 of the push-button switch 418 comes in electrical communication with the flexible, stationary electrical contact 412, closing an electrical circuit including the LED 120c and battery 156c, and powering the LED 120c. The LED 120c is turned off by releasing the finger pressure on the push button 420. Releasing pressure on the push button 420 allows the spring 424 to urge the push button 420 laterally outward, preventing electrical communication between the movable contact 416 and the stationary contact 412.

With reference to FIG. 8, a ring light 500 constructed in accordance with a still further embodiment of the invention is shown. Elements similar to those described above are identified with like reference numerals, but with a “d” suffix. The ring light 500 is similar to the ring light 400 described above with respect to FIG. 5, but the hemispherical shell 116c is replaced with a disc-shaped shell or housing 304d (See FIG. 4), preferably a gem or a fake gem. The disc-shaped shell 304d is fixed within the recess 112d to an annular base 308d.

Use of the ring light 500 is similar to the use of the ring light 400 described above with respect to FIGS. 5-7.

With reference to FIG. 9, a ring light 600 constructed in accordance with yet a further embodiment of the invention will now be described. The ring light 600 preferably has a construction similar to the ring lights 400, 500 illustrated in FIGS. 5 and 8, but instead of the push-button switch 420e being located on the side of the ring 104e, the push-button switch 420e is located at a proximal end 604 of the ring 104e. The ring light 600 may include a housing 608 with a wedge-shaped window 612. The window 612 is used to direct light in the direction shown, away from the user. One or more mirrors may be used to direct light emitted from the light source. In an alternative embodiment, other window configurations may be used. The window 612 may include a diffusion material to diffuse light emitted from the light source or a magnifying material to magnify or direct light.

In another embodiment, the housing 608 may be movable to actuate the ring light 600, similar to the ring lights 100, 200, 300 discussed above with respect to FIGS. 1-4.

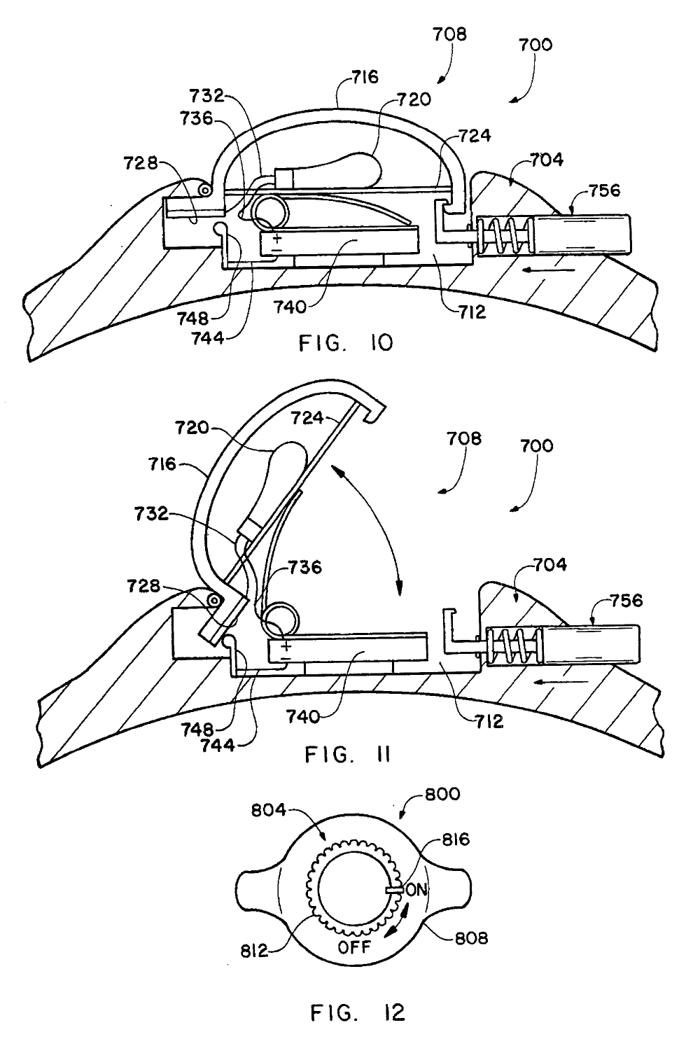

With reference to FIG. 10, a ring light 700 constructed in accordance with a yet further embodiment of the invention will be described. The ring light 700 includes a ring 704 and a light housing 708. The light housing 708 is disposed partially within a recessed area 712 of the ring 704.

The light housing 708 includes a generally hemispherical shell or housing 716 that covers a light source 720, preferably a LED. The LED 720 is carried by a translucent support surface 724. An electrical contact 728 on an outer surface of the shell 716 may be electrically connected to the light source 720 by a first electrical coupling 732. A second electrical coupling 736 electrically connects the light source 720 to a positive terminal of a power source 740. A third electrical coupling 744 connects a negative terminal of the power source 740 to a second contact 748. The light housing 708 may be rotatably received within the recess 712. The shell 716 may be pivotally attached to the ring 704 or a rotatable base (not shown) for pivotal movement between a first or “off” position (FIG. 10) and a second or “on” position (FIG. 11). A latch mechanism 756 may be used to retain the shell 716 in the “off” position.

The ring light 700 will now be described in use. The shell 716 is normally disposed in the closed or “off” position illustrated in FIG. 10. In this position, the electrical circuit is open, preventing the power source 740 from supplying power to the light source 720. To activate the light source 720, the shell 716 is pivoted to the second or “on” position illustrated in FIG. 11. This may be done by pulling on the latch mechanism 756 and pivoting the shell 716 upwards. The housing 708 may include a spring that normally biases the shell 716 upwards so that pulling on the latch mechanism 756 automatically causes the shell 716 to pivot upwards. In the second or “on” position, the first contact 728 contacts the second contact 748, allowing the power source 740 to supply power to the light source 720 to activate the light source 720. Light is transmitted through the translucent support 724 and/or shell 716 to illuminate a desired object or to provide general illumination. If the light housing 708 is rotatable relative to the recess 712, the light housing 708 may be rotated to a desired position to provide illumination in a desired direction. The light source 720 may be deactivated by pressing downwardly on the shell 716 so that the latch mechanism 712 retains the shell 716 in the closed position.

In a further embodiment, the light source 720 may reside in a base or directly above the power source 740 instead of within the shell 716. In this embodiment, the support 724 may be a mirror that reflects and re-directs light emitted from light source 720. With reference to FIG. 12, a ring light 800 constructed in accordance with an additional embodiment will be described. The ring light 800 is similar to the ring light embodiments described above, except a light housing 804 is rotatable relative to a ring 808 for movement between an “on” position and an “off” position. In the “on” position, an electrical circuit is closed, causing a power source to activate a light source. In the “off” position, the electrical circuit is open, preventing the power source from activating the light source. The light housing 804 may include a serrated friction surface 812 and/or a protrusion 816 to control rotation of the light housing 804.

Accordingly, it will be readily apparent to those skilled in the art that still further changes and modifications in the actual concepts described herein can readily be made without departing from the spirit and scope of the invention as defined by the following claims.

What is claimed is:

1. A method of using a ring light, comprising:
providing a ring light over a user's finger so that the finger extends both distally of and proximally of the ring light, the ring light including at least one light source and at least one power source;
actuating the at least one light source using a finger other than the finger used to carry the ring light.

2. The method of claim 1, wherein the step of providing the ring light over a user's finger occurs before the step of actuating the at least one light source.

3. The method of claim 1, wherein the step of providing the ring light over a user's finger occurs after the step of actuating the at least one light source.

4. The method of claim 1, wherein the ring light includes a movable shell and a ring, and the step of actuating the at least one light source includes moving the movable shell to actuate the light source.

5. The method of claim 4, where the at least one light source is actuated by pushing the shell downwards.

6. The method of claim 5, wherein the at least one light source is actuated only as long as the movable shell is pushed down.

7. The method of claim 5, wherein the at least one light source is actuated for a predetermined period of time after the shell is pushed down.

8. The method of claim 4, where the at least one light source is actuated by rotating the shell.

9. The method of claim 4, where the at least one light source is actuated by pivoting the shell upwards.

10. The method of claim 1, wherein the ring light includes a push-button switch, and the step of actuating the at least one light source includes pushing the push-button switch to actuate the at least one light source.

11. The method of claim 1, wherein the ring light includes an on/off switch, and the step of actuating the at least one light source includes switching the switch to an “on” position to actuate the at least one light source.

12. The method of claim 1, wherein the at least one light source is at least one LED.

13. The method of claim 12, wherein the at least one light source is at least one white LED.

14. The method of claim 12, wherein the at least one light source is at least one colored LED.

15. The method of claim 1, wherein the ring light is disposable.

16. The method of claim 1, wherein the at least one power source is changeable.

17. The method of claim 1, wherein the at least one power source is at least one watch battery.

18. The method of claim 1, wherein the ring light includes a rotatable light housing that houses the at least one light source, and the method further includes rotating the light housing.

19. The method of claim 1, wherein the ring light includes a dimmer mechanism, and the method further includes adjusting the brightness of the at least one light source with the dimmer mechanism.

20. The method of claim 1, wherein the ring light includes an intermittent flashing mechanism, and the method further includes actuating the intermittent flashing mechanism so that the at least one light source flashes repeatedly.

21. The method of claim 1, wherein the ring light includes a light housing with a translucent window.

22. The method of claim 21, wherein the window includes a diffuser to diffuse emitted light from the at least one light source.

23. The method of claim 1, wherein the ring light includes one or more reflective surfaces to direct emitted light from the light source.

24. A ring light, comprising:
a ring adapted to be inserted over a user's finger so that the finger extends both distally of and proximally of the ring;
at least one power source carried by ring;
at least one light source powered by the at least one power source; and
a shell covering the at least one power source and the at least one light source.

25. The ring light of claim 24, wherein the ring light includes a ring and a movable shell to actuate the at least one light source.

26. The ring light of claim 25, where the movable shell is adapted to be moved downwardly to actuate the at least one light source.

27. The ring light of claim 26, wherein the at least one light source is adapted to be actuated only as long as the movable shell is pushed down.

28. The ring light of claim 26, wherein the at least one light source is adapted to be actuated for a predetermined period of time after the shell is pushed down.

29. The ring light of claim 25, where the movable shell is adapted to be rotated to actuate the at least one light source.

30. The ring light of claim 25, where the movable shell is adapted to be pivoted upwards to actuate the at least one light source.

31. The ring light of claim 24, wherein the ring light includes a push-button switch to actuate the at least one light source.

32. The ring light of claim 24, wherein the ring light includes an on/off switch to activate and deactivate the at least one light source.

33. The ring light of claim 24, wherein the at least one light source is at least one LED.

34. The ring light of claim 24, wherein the at least one light source is at least one white LED.

35. The ring light of claim 24, wherein the at least one light source is at least one colored LED.

36. The ring light of claim 24, wherein the ring light is disposable.

37. The ring light of claim 24, wherein the at least one power source is changeable.

38. The ring light of claim 24, wherein the at least one power source is at least one watch battery.

39. The ring light of claim 24, wherein the ring light includes a rotatable light housing.

40. The ring light of claim 24, wherein the ring light includes a dimmer mechanism to control the brightness of the at least one light source.

41. The ring light of claim 24, wherein the ring light includes an intermittent flashing mechanism to cause the at least one light source to flash repeatedly.

42. The ring light of claim 24, wherein the ring light includes a light housing with a translucent window.

43. The ring light of claim 42, wherein the window includes a diffuser to diffuse emitted light from the at least one light source.

44. The ring light of claim 24, wherein the ring light includes one or more reflective surfaces to direct emitted light from the light source.
